(19) United States
(12) Patent Application Publication
(10) Pub. No.: US 2005/0270995 A1
(43) Pub. Date: Dec. 8, 2005

(54) Mobile communication terminal and method for processing communication function during DMB output

(75) Inventors: Hye-Jung Byun, Bupyeong-gu (KR); Hoon Yoo, Suwon-si (KR); Yong-Gu Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/109,998

(22) Filed: Apr. 20, 2005

(30) Foreign Application Priority Data
Jun. 8, 2004 (KR) 2004-41647

(51) Int. Cl. H04J 3/24

(52) U.S. Cl. 370/312

(57) ABSTRACT

Disclosed is a mobile communication terminal and a method for processing a communication function during DMB output. The mobile communication terminal includes a digital broadcasting data receiving unit for receiving digital broadcasting data, a communication state detecting unit for controlling storage or output of received digital broadcasting data based on communication state information of the mobile communication terminal, a storage unit for storing the received digital broadcasting data under a control of the communication state detection unit, and an output unit for outputting the received digital broadcasting data or the digital broadcasting data stored in the storage unit. The method includes the steps of determining whether a communication request is generated during the digital broadcasting output and, if the communication request is generated, stopping digital broadcasting data output and storing received digital broadcasting data.

### PRIORITY

This application claims priority to an application entitled “Mobile Communication Terminal and Method for Processing Communication Function During DMB Output” filed in the Korean Intellectual Property Office on Jun. 8, 2004 and assigned Ser. No. 2004-41647, the contents of which are incorporated herein by reference.

### BACKGROUND OF THE INVENTION

1. Field of the Invention

The present invention relates to a mobile communication terminal capable of receiving digital broadcasting data, and more particularly to a mobile communication terminal and a method for processing a communication function during digital broadcasting data output.

2. Description of the Related Art

Recently, there has been an increased interest in a digital broadcasting service using a mobile communication terminal, particularly, a digital-multimedia-broadcasting (“DMB”) service.

The DMB service implies a broadcasting service enabling subscribers to view or listen to various multimedia broadcasting services through multiple channels by means of a portable receiver or a vehicle receiver having an omni-directional receive antenna even when the subscribers are outdoors or while they are on the move.

FIG. 1 shows a structure of a system for realizing the DMB service. The system for realizing the DMB service includes a data transmitting center 10, a satellite 20, and receive apparatuses (e.g., a mobile communication terminal 30, a vehicle receiver 40, and a home receiver 50). The data transmitting center 10 compresses and modulates digital-multimedia-broadcasting data (e.g., video, audio, data, etc.), thereby transmitting the digital-multimedia-broadcasting data to the satellite 20. The satellite 20 receives, amplifies, and then frequency transforms signals transmitted from the data transmitting center 10 and retransmits the signal to the ground. Receive apparatuses such as the mobile communication terminal 30, the vehicle receiver 40, and/or the home receiver 50 can each receive, decode, and then decompress the signals retransmitted from the satellite 20 and convert the signals into original signals so as to output the signals.

At this time, when receiving a communication request signal while viewing or listening to DMB using the mobile communication terminal 30 from among apparatuses such as the mobile communication terminal 30, the vehicle receiver 40, and/or the home receiver 50, the user must select one of a DMB outputting function and a communication function.

Accordingly, if performing telephone communication while viewing or listening to DMB, the user cannot view and/or listen to DMB corresponding to telephone communication time.

### SUMMARY OF THE INVENTION

Accordingly, the present invention has been made to solve the above-mentioned problems occurring in the prior art, and an object of the present invention is to provide a mobile communication terminal and a method, which can simultaneously provide a communication function without the loss of digital broadcasting data and also provide a digital broadcasting data output.

It is another object of the present invention to provide a mobile communication terminal and a method which can enhance the quality of a digital broadcasting service using a mobile communication terminal.

It is still another object of the present invention is to provided a mobile communication terminal and a method which can conveniently provide a digital broadcasting viewing or listening function and a communication function to a digital broadcasting service user using a mobile communication terminal.

To accomplish the above and other objects, there is provided a mobile communication terminal including a digital broadcasting data receiving unit for receiving digital broadcasting data, a communication state detecting unit for controlling storage or output of received digital broadcasting data based on communication state information of the mobile communication terminal, a storage unit for storing the received digital broadcasting data under control of the communication state detection unit, and an output unit for outputting the received digital broadcasting data or the digital broadcasting data stored in the storage unit.

According to another aspect of the present invention, there is provided a method for processing a communication function during digital broadcasting output by a mobile communication terminal, the method including the steps of determining whether a communication request is generated during the digital broadcasting output, and if the communication request is generated, stopping digital broadcasting data output and storing received digital broadcasting data. In particular, the method further includes the steps of extracting and outputting the stored digital broadcasting data in a sequence according to a length of time during which the stored digital broadcasting data are stored after the communication is terminated and scrambling the digital broadcasting data before the digital broadcasting data are stored.

### BRIEF DESCRIPTION OF THE DRAWINGS

The above and other objects, features and advantages of the present invention will be more apparent from the following detailed description taken in conjunction with the accompanying drawings, in which:

FIG. 1 shows a structure of a system for realizing a DMB service;

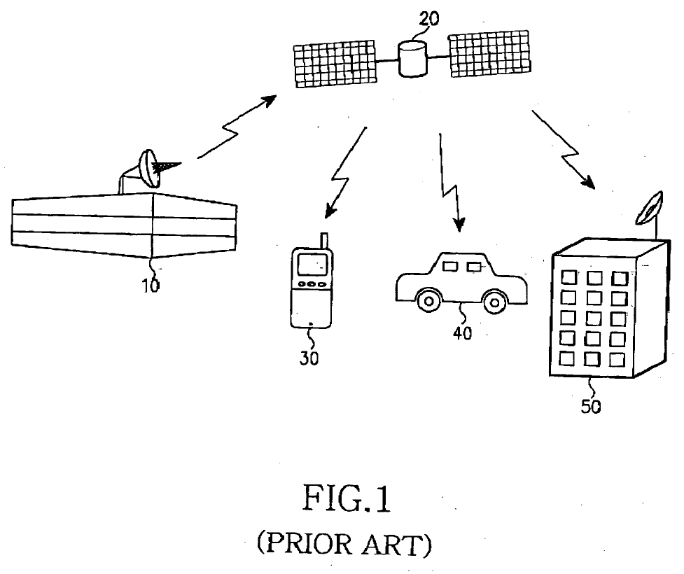

FIG. 2 is a schematic block diagram illustrating a structure of a mobile communication terminal according to an embodiment of the present invention;

FIG. 3 is a block diagram illustrating a structure of a DMB control unit of a mobile communication terminal according to an embodiment of the present invention; and

FIG. 4 is a flowchart illustrating a method for processing a communication function during DMB output according to an embodiment of the present invention.

### DETAILED DESCRIPTION OF THE PREFERRED EMBODIMENT

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear. Although DMB from among digital broadcasting services will be described in the following description, it is well known to those skilled in the art that the present invention can be applied to other digital broadcasting services.

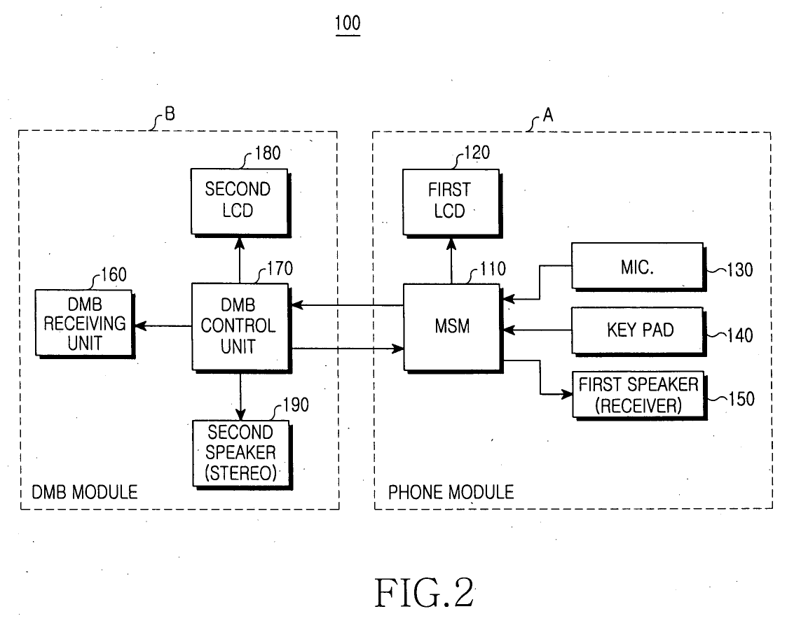

FIG. 2 is a schematic block diagram illustrating a mobile communication terminal 100 according to an embodiment of the present invention. The mobile communication terminal 100 according to the present invention includes a portable phone function module (phone-module) A for controlling the portable phone function and a broadcasting function module (DMB module) B for controlling the broadcasting receiving function.

The phone-module A includes a main control unit (MSM) 110 (which can be realized using a mobile station modem chip for controlling the overall function of the mobile communication terminal including the portable phone function, a first liquid crystal display (LCD) 120 for displaying information relating to the overall function of the mobile communication terminal including the portable phone function, a microphone 130 for receiving an audio signal, a key pad 140 used for inputting a control command to the MSM 110, and a first speaker 150 for outputting an audio signal relating to the execution of the portable phone function. Herein, the first speaker 150 operates as a receiver for receiving sound signals and outputting a corresponding tone.

In the meantime, the DMB module B includes a DMB receiving unit 160 for receiving DMB data, a DMB control unit 170 used for outputting information provided to a user by decoding the DMB data, a second LCD 180 for displaying image information output from the DMB control unit 170, and a second speaker 190 for outputting an audio signal output from the DMB control unit 170. Herein, the second speaker 190 outputs sound information included in multimedia information and can providean optional stereo function. In addition, the second LCD 180 outputs image information included in the multimedia information. The second speaker 190 and the second LCD 180 are included in an output interface unit for outputting digital broadcasting. The output interface unit includes one of a speaker and an LCD according to types of the digital broadcasting. For example, in the case of a mobile communication terminal for processing only digital audio broadcast, only a speaker is included in the output interface unit. Alternatively, if it is envisioned that the mobile communication terminal will be used for both digital, audio and video broadcastings both at least one speaker and a video display such as an LCD can be provided.

In alternative embodiments, the first speaker 150 and the second speaker 190 can be formed integrally with each other such that only one speaker is provided. Likewise, the first LCD 120 and the second LCD 180 can be formed integrally with each other.

In particular, the DMB control unit 170 stores the DMB data received from the DMB receiving unit 160 in the internal memory while the mobile communication terminal 110 is performing the communication function and then outputs the DMB data after the termination of the communication. In detail, the DMB control unit 170 receives communication state information from the MSM 110 and processes the received DMB data according to the communication state information.

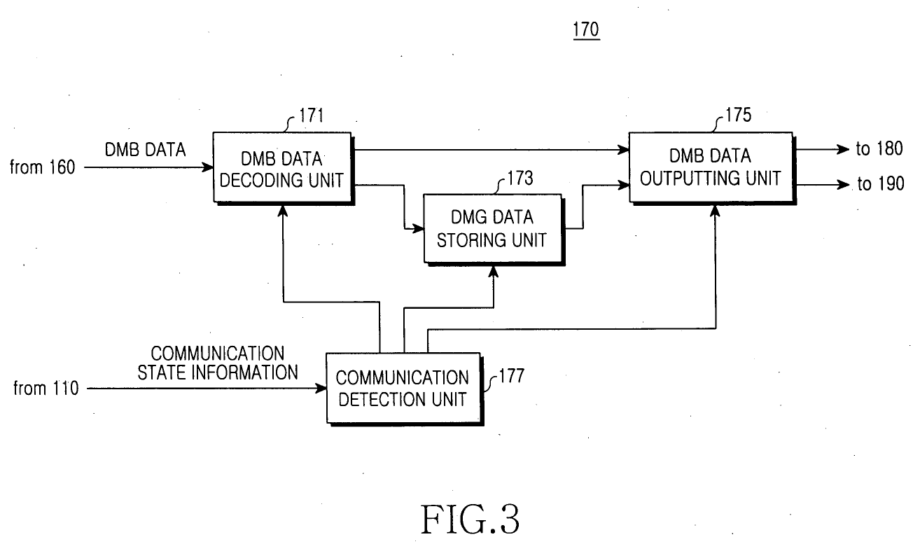

FIG. 3 is a block diagram illustrating a structure of the DMB control unit 170 of the mobile communication terminal according to an embodiment of the present invention. The DMB control unit 170 includes a DMB data decoding unit 171, a DMB data storing unit 173, a DMB data outputting unit 175, and a communication state detecting unit 177.

The communication state detecting unit 177 receives the communication state information from the MSM 110 according to whether the phone-module A performs a communication function and controls operations of the DMB data decoding unit 171, the DMB data storing unit 173, and the DMB data outputting unit 175 according to the communication state information.

For example, if the communication state detecting unit 177 detects that the MSM 110 performs the communication function, the communication state detecting unit 177 outputs an output stop signal to the DMB data outputting unit 175 so as to stop outputting DMB data. In addition, the communication state detecting unit 177 outputs a data storing signal to the DMB data decoding unit 171 and the DMB data storing unit 173 so as to allow the DMB data decoding unit 171 to deliver decoded DMB data to the DMB data storing unit 173 and allow the DMB data storing unit 173 to store the DMB data. In the meantime, if the communication state detecting unit 177 detects that the MSM 110 terminates the communication function, the communication state detecting unit 177 outputs an output start signal to the DMB data storing unit 173 and the DMB data outputting unit 175 so as to allow the DMB data stored in the DMB data storing unit 173 to be output through the DMB data outputting unit 175.

The DMB data decoding unit 171 decodes and outputs DMB data received through the DMB receiving unit 160. Herein, since it is assumed that the DMB data includes video data and audio data, the DMB data decoding unit 171 separates the video data and the audio data and then performs demutiplexing and decoding. After that, the DMB decoding unit 171 outputs the decoded video data and audio data to one of the DMB data outputting unit 175 and the DMB data storing unit 173 under the control of the communication state detecting unit 177. For example, if the DMB data decoding unit 171 delivers decoded DMB data to the DMB data outputting unit 175 and, if a data storing signal is delivered from the communication state detecting unit 177 is input into the data storing unit 173 in the first stage of the DMB operation, the decoded DMB data is delivered to the DMB data storing unit 173. In particular, the DMB data decoding unit 171 stores the decoded DMB data in the DMB data storing unit 173 until a corresponding DMB program is terminated after receiving the data storing signal. Thus, it is seen that the DMB data decoding unit, when outputting decoded DMB data, only outputs the data to one of the DMB data outputting unit 175 and the DMB data storing unit 173.

The DMB data storing unit 173 stores DMB data delivered from the DMB data decoding unit 171 and/or outputs the stored DMB data under the control of the communication state detecting unit 177. For example, if the data storing signal from the communication state detecting unit 177 is input into the data storing unit 173, the DMB data storing unit 173 stores the DMB data delivered from the DMB data decoding unit 171. In addition, if the output start signal from the communication state detecting unit 177 is input into the data storing unit 173, the stored DMB data is then delivered to the DMB data outputting unit 175. Herein, the DMB data storing unit 173 extracts DMB data in a sequence in which the DMB data is stored, that is, in a sequence according to the length of time during which the DMB data is stored and delivers the DMB data to the DMB data outputting unit 175. In addition, while providing the DMB data to the DMB data outputting unit 175, the DMB data storing unit 173 can receive and store DMB data received in real time from the DMB data decoding unit 171.

The DMB data outputting unit 175 outputs DMB data delivered from the DMB data decoding unit 171 or the DMB data storing unit 173. In other words, the DMB data outputting unit 175 delivers video data from among DMB data to the second LCD (reference numeral 180 of FIG. 3) and audio data from among the DMB data to the second speaker (reference numeral 190 of FIG. 3).

Herein, the DMB data storing unit 173 in actual use may be incorporated into in the mobile communication terminal as shown in FIG. 3. In addition, an external memory (not shown e.g., RAM, ROM etc.) can be used for or by the DMB data storing unit 173. However, when the DMB data storing unit 173 includes the external memory, it is preferred that an optional step of scrambling DMB data using a predefined scrambling technique or algorithm is performed before the DMB data is stored in the DMB data storing unit 173 in order to provide for copyright protection of the DMB data. To this end, it is preferred that the DMB module 170 further includes a scrambling control unit (not shown).

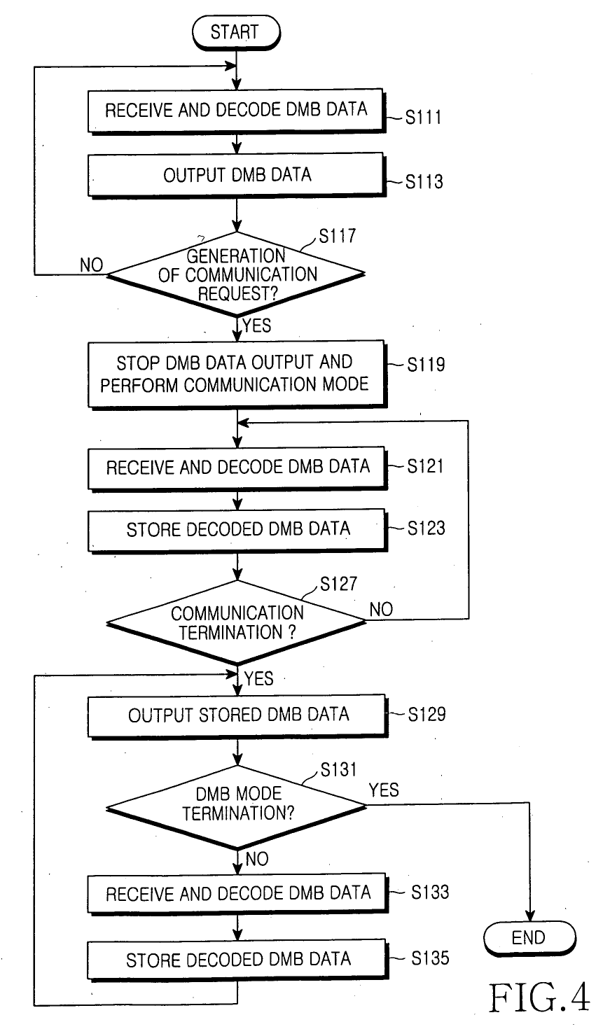

FIG. 4 is a flowchart illustrating a method for processing a communication function during a DMB output according to one embodiment of the present invention. In other words, FIG. 4 is a flowchart illustrating a method in which a mobile communication terminal processes the communication function according to an embodiment of the present invention when the communication function is requested while a user is viewing or listening to a DMB (i.e., in a DMB mode) by using the mobile communication terminal.

The mobile communication terminal determines whether a communication request is generated while repeating a series of steps S111 and S113 of outputting DMB data after receiving and decoding the DMB data (S117).

Herein, the communication request is generated when a call is received by the mobile communication terminal and/or when a user selects the communication function in order to originate a call. For example, when a call is received, the mobile communication terminal informs the user of the received call such that the user may determine to perform the communication function. For example, the mobile communication terminal can optionally display a message such as “incoming call” or a caller's identification such as an originating number of the caller by overlaying the caller's originating number on a DMB screen and then allow the user to accept, reject or ignore the communication request or the reception of a corresponding call by providing the user of the mobile communication terminal the option to do so. In alternative embodiments, a musical melody, tone, a flash, a vibration, etc., optionally preselected by the mobile terminal's user, may be used to alert mobile communication the terminal's user of a recited tone.

In step S117, if the user selects a DMB data outputting function, the mobile communication terminal repeats the steps S111 and S113. However, if the user selects the communication function and if a corresponding communication is started, the mobile communication terminal stops DMB data output and performs a communication mode (S119). At this time, a DMB data receiving and decoding step is maintained (S121). In detail, although the DMB data output is stopped in order to support the communication function of the user, the real-time DMB data receiving and decoding step S121 performed in the mobile communication terminal is continuously performed. In addition, the DMB data through the step S121 are stored (S123). The steps S121 and S123 are repeatedly performed until the communication is terminated.

In step S123, the DMB data storage is necessary because the DMB data storage helps to overcome a disadvantage in which the user cannot view and/or listen to DMB simultaneously with a communication (i.e. a call etc.). In other words, the DMB data storage is necessary in order to provide the DMB service by using the DMB data stored through the steps S121 and S123 when the communication is terminated.

If the communication is terminated, the DMB data stored in step S123 are output (S129). Alternatively, if the communication is not terminated in step S127, the DMB data receiving and decoding step S121, a decoded DMB data storing step S123 is repeated. After the termination of a communication in step S127, stored DMB data is output (S129).

Herein, it is preferred that the DMB data storing step S123 and the DMB data outputting step S129 further include a step of optionally scrambling the DMB data, as discussed above, in order to adequately assure copyright protection of the DMB data. For example, when the DMB data is stored in an external device (e.g., an external memory), it is preferred that an appliance number or other unique identifier of a corresponding mobile communication terminal is included in the DMB data which is stored in step S123, and that step S129 further includes a step of comparing an appliance number stored in a mobile communication terminal intending to output the DMB data with an appliance number or other unique identifier included in the DMB data. Accordingly, through the comparison step, only an authorized mobile communication terminal (e.g., a mobile communication terminal previously authorized to use the DMB data or a mobile communication terminal of a subscriber having paid costs corresponding to the use of the DMB data) can output the DMB data. As a result, it is possible to assure copyright protection of corresponding DMB data and to prevent piracy of the DMB data. If the DMB mode is not ended in step S131, steps S133 and S135 (which are similar to steps S111 and S113 and S121 and S123 above, respectively and will not be further described) are performed and DMB data is then output in step S129. Alternatively, if the DMB mode is terminated in step S131, the process ends.

In the meantime, although the communication request in step S117 may be generated through a method for informing a user of a call reception such that the user may determine to perform the communication function, the present invention is not limited to the method.

For example, the present invention can initiate a generation of the communication request and instantaneously entering into a communication mode upon receipt of a call reception.

Also, before starting to receive the DMB data, a mobile communication terminal allows a user to preset handling information about the case of receiving a call during the viewing and/or the listening to of a DMB and may determine an operation mode thereof based on the set information. Specifically, the user can preset the operation modes of the mobile communication terminal before the initiation of the reception of the DMB data. For example a user can reset the operation modes of the mobile communication terminal so that when a call is received while a user views the DMB (1) the incoming call is ignored by the mobile communication terminal; (2) if the user answers the call and DMB data received during communication is recorded by the mobile communication terminal; and (3) if the user answers the call DMB data received during communication is not recorded by the mobile communication terminal. In step 117, the operation mode of the mobile communication terminal is determined based on the information preset by the user.

In the above described example, if the user sets the handling information to correspond to the first option, the mobile communication terminal may determine that the user refuses the communication in step S117 so as to perform steps after step S117. If the user sets the handling information to correspond to the second option, the mobile communication terminal may determine that the user accepts the communication and requests the received DMB data recording in step S117 so as to perform steps after step S119. In the meantime, if the user sets the handling information to correspond to the third option the mobile communication terminal may stop receiving the DMB data and answers the phone similarly to a conventional telephone answering method.

In addition, the communication request is generated when a call is originated as well as when a call is received. In detail, the communication request may be generated when the phone number of the other party is input from the user, when the call is originated, or when communication with the other party is achieved after the call is originated.

In the meantime, when the user sets the handling information to correspond to the second option, it is preferred that the mobile communication terminal allow the user to optionally set maximum recording time and recording capacity information for the received DMB data recording. Moreover, it is preferred that a storage space of the mobile communication terminal be taken into consideration. This is necessary in order to prevent problems caused by storing amount of DMB data which exceeds the storage capacity of the mobile communication terminal because the amount of the DMB data to be stored in the mobile communication terminal's memory.

As described above, according to the present invention, when a user performs a communication function while viewing or listening to a DMB using a mobile communication terminal, the DMB data received after the start of the communication function is stored and then output upon the ending of the communication, thereby preventing the loss of DMB data due to the communication. In other words, when engaging in a communication function of the mobile communication terminal while viewing or listening to a DMB, the mobile communication terminal stores a part of the DMB not viewed nor listened to due to the communication so that the user can view the DMB after the communication has ended.

While the invention has been shown and described with reference to certain preferred embodiments thereof, it will be understood by those skilled in the art that various changes in form and details may be made therein without departing from the spirit and scope of the invention. That is, it is well know to those skilled in the art that, although DMB in a digital broadcasting service is described by way of example in the present description, the present invention should not be limited to DMB service, but may be applied to other digital broadcasting services (e.g., digital audio broadcasting (DAB), digital audio radio (DAR), digital radio broadcasting (DRB), and digital sound broadcasting (DSB)). Consequently, the scope of the invention should not be limited to the embodiments, but should be defined by the appended claims and equivalents thereof.

1. A mobile communication terminal for processing a communication function during digital broadcasting output, the mobile communication terminal comprising:
a digital broadcasting data receiving unit for receiving digital broadcasting data;
a communication state detecting unit for controlling storage and/or output of received digital broadcasting data based on communication state information of the mobile communication terminal;
a storage unit for storing the received digital broadcasting data under a control of the communication state detecting unit; and
an output unit for outputting the received digital broadcasting data and/or the digital broadcasting data stored in the storage unit.

2. The mobile communication terminal as claimed in claim 1, further comprising an output interface unit for outputting the digital broadcasting data output from the output unit.

3. The mobile communication terminal as claimed in claim 2, wherein the output interface unit includes:
a display unit for outputting the digital broadcasting data in a visible form; and
a speaker unit for outputting the digital broadcasting data in an audible form.

4. The mobile communication terminal as claimed in claim 1, further comprising a scrambling control unit for scrambling digital broadcasting data before the digital broadcasting data is stored in the storage unit and for analyzing scrambled digital broadcasting data when the digital broadcasting data is read from the storage unit.

5. The mobile communication terminal as claimed in claim 1, wherein, if the communication state detecting unit detects that the mobile communication terminal starts a communication, the communication state detecting unit stops an output operation of the output unit and allows the storage unit to store the received digital broadcasting data.

6. The mobile communication terminal as claimed in claim 2, wherein, if the communication state detecting unit detects that the mobile communication terminal starts a communication, the communication state detecting unit stops an output operation of the output unit and allows the storage unit to store the received digital broadcasting data.

7. The mobile communication terminal as claimed in claim 3, wherein, if the communication state detecting unit detects that the mobile communication terminal starts a communication, the communication state detecting unit stops an output operation of the output unit and allows the storage unit to store the received digital broadcasting data.

8. The mobile communication terminal as claimed in claim 4, wherein, if the communication state detecting unit detects that the mobile communication terminal starts a communication, the communication state detecting unit stops an output operation of the output unit and allows the storage unit to store the received digital broadcasting data.

9. The mobile communication terminal as claimed in claim 1, wherein, if the communication state detecting unit detects that the mobile communication terminal terminates a communication, the communication state detecting unit starts an output operation of the output unit and allows the storage unit to output the stored digital broadcasting data in a sequence according to a time in which the digital broadcasting data is stored, while storing the received digital broadcasting data and delivering the output digital broadcasting data to the output unit.

10. The mobile communication terminal as claimed in claim 2, wherein, if the communication state detecting unit detects that the mobile communication terminal terminates a communication, the communication state detecting unit starts an output operation of the output unit and allows the storage unit to output the stored digital broadcasting data in a sequence according to a time in which the digital broadcasting data is stored, while storing the received digital broadcasting data and delivering the output digital broadcasting data to the output unit.

11. The mobile communication terminal as claimed in claim 3, wherein, if the communication state detecting unit detects that the mobile communication terminal terminates a communication, the communication state detecting unit starts an output operation of the output unit and allows the storage unit to output the stored digital broadcasting data in a sequence according to a time in which the digital broadcasting data is stored, while storing the received digital broadcasting data and delivering the output digital broadcasting data to the output unit.

12. The mobile communication terminal as claimed in claim 4, wherein, if the communication state detecting unit detects that the mobile communication terminal terminates a communication, the communication state detecting unit starts an output operation of the output unit and allows the storage unit to output the stored digital broadcasting data in a sequence according to a time in which the digital broadcasting data is stored, while storing the received digital broadcasting data and delivering the output digital broadcasting data to the output unit.

13. A method for processing a communication function during a digital broadcasting output by a mobile communication terminal, the method comprising the steps of:
determining whether a communication request is generated during the digital broadcasting output; and
if the communication request is generated, stopping digital broadcasting data output and storing received digital broadcasting data.

14. The method as claimed in claim 13, further comprising a step of extracting and outputting the stored digital broadcasting data in a sequence according to a time in which the stored digital broadcasting data is stored, after the communication is terminated.

15. The method as claimed in claim 13, wherein an operation mode of the mobile communication terminal is determined based on information set by a user when the communication request is generated.

16. The method as claimed in claim 14, wherein an operation mode of the mobile communication terminal is determined based on information set by a user when the communication request is generated.

17. The method as claimed in claim 13, wherein the storage step includes a step of scrambling the digital broadcasting data before the digital broadcasting data is stored.

18. The method as claimed in claim 14, wherein the storage step includes a step of scrambling the digital broadcasting data before the digital broadcasting data is stored.

19. The method as claimed in claim 15, wherein the stored digital broadcasting data outputting step further includes analyzing the scrambled and stored digital broadcasting data before the scrambled and stored digital broadcasting data is output.
